(19) United States
(12) Patent Application Publication
(10) Pub. No.: US 2011/0238393 A1
(43) Pub. Date: Sep. 29, 2011

(54) SPICE MODEL PARAMETER OUTPUT APPARATUS AND METHOD, AND RECORDING MEDIUM

(75) Inventors: Sadayuki YOSHITOMI, Tokyo (JP); Naoki Wakita, Kawasaki-Shi (JP); Fumie Fujii, Yokohama-Shi (JP); Yuka ITANO, Kawasaki-Shi (JP)

(73) Assignee: KABUSHIKI KAISHA TOSHIBA, Tokyo (JP)

(21) Appl. No.: 12/886,895

(22) Filed: Sep. 21, 2010

(30) Foreign Application Priority Data
Mar. 25, 2010 (JP) 2010-70578

(51) Int. Cl. G06G 7/48

(52) U.S. Cl. 703/4

(57) ABSTRACT

In one embodiment, a SPICE model parameter output apparatus is configured to output a SPICE model parameter of a high-frequency or analog MOSFET for a simulation of a semiconductor circuit. The apparatus includes a data input part to input shape data of the MOSFET and measurement data on frequency characteristics of the MOSFET. The apparatus further includes a substrate resistance calculating part configured to calculate a substrate resistance of a one-terminal substrate resistance model regarding the MOSFET, based on the measurement data. The apparatus further includes a SPICE model parameter output part configured to calculate the SPICE model parameter, based on the substrate resistance of the one-terminal substrate resistance model and the shape data, to output the calculated SPICE model parameter.

### CROSS REFERENCE TO RELATED APPLICATION

This application is based upon and claims the benefit of priority from the prior Japanese Patent Application No. 2010-70578, filed on Mar. 25, 2010, the entire contents of which are incorporated herein by reference.

### FIELD

An embodiment described herein relates to a SPICE (Simulation Program with Integrated Circuit Emphasis) model parameter output apparatus and method, and recording medium, for example, to a MOSFET model to be used in a SPICE circuit simulation, such as a SPICE model of a MOSFET used in a high-frequency circuit and an RF analog circuit.

### BACKGROUND

When a semiconductor integrated circuit is designed, substrate resistance model parameters (for example, RSUB1, RSUB2, RSUB3, and RSUB4) of a high-frequency MOSFET are calculated for modeling thermal noise.

Optimum values of the substrate resistance model parameters can be calculated, for example, by varying the values of the substrate resistance model parameters with regard to an S parameter (particularly, S22). In this method, even if the values are not true values, the calculation can be performed. However, a correct thermal noise simulation result often cannot be obtained.

In an article “A Simple and Accurate Method for Extracting Substrate Resistance of RF MOSFETs” (Jeonghu Han et al., IEEE ELECTRON DEVICE LETTERS, VOL. 23, NO. 7, JULY 2002), an equivalent circuit is calculated using the S parameter measured after setting a gate voltage to have a lower value than a threshold voltage. However, in this method, a conductance between a drain and a source (gds) of an MOSFET and a conductance between a substrate and the drain/source (gmb) of the MOSFET are not removed, so that the S parameter including only a parasitic component cannot be obtained. This makes it difficult to extract a correct substrate resistance. Furthermore, since the targeted substrate resistance model is a one-terminal model, the accuracy at high frequency is reduced.

JP-A 2005-268417 (KOKAI) discloses a method of generating an equivalent circuit model by measuring S parameter data under a condition that each device is turned on and under a condition that each device is turned off.

When the semiconductor integrated circuit is designed, the substrate resistance model parameters of an analog MOSFET are also often calculated. In this case, there also occurs a problem similar to that in the case of the high-frequency MOSFET.

### BRIEF DESCRIPTION OF THE DRAWINGS

FIG. 1 is a schematic diagram showing a configuration of a SPICE model parameter output apparatus of an embodiment of the disclosure;

FIG. 2 is a circuit diagram showing general configurations of macro models of high-frequency MOSFETs;

FIG. 3 is a plan view showing MOSFETs handled in the present embodiment, where the MOSFETs are arranged in the form of an array;

FIG. 4 is a circuit diagram showing an internal equivalent circuit of a MOSFET when S parameters 1 and 2 are measured;

FIG. 5 is a circuit diagram showing an admittance that can be defined when the MOSFET is viewed from a gate side in the state shown in FIG. 4;

FIG. 6 is a circuit diagram showing an admittance that can be defined when the MOSFET is viewed from a drain side in the state shown in FIG. 4;

FIG. 7 is a graph showing values of Re(1/Y₂₂) and a substrate resistance R_{B} actually obtained by the method of the present embodiment;

FIG. 8 is a circuit diagram for explaining a transformation from a one-terminal substrate resistance model to a four-terminal substrate resistance model;

FIG. 9 is a side cross-sectional view illustrated by associating the structure shown in FIG. 3 with four-terminal substrate resistances RSUB1 to RSUB4;

FIG. 10 is a graph in which a model of the present embodiment and a measured result are compared using the values of RSUB1 to RSUB4 obtained by the method of the present embodiment; and

FIG. 11 is a circuit diagram showing parasitic elements of the MOSFET handled in the present embodiment.

### DETAILED DESCRIPTION

Embodiments will now be explained with reference to the accompanying drawings.

An embodiment described herein is, for example, a SPICE model parameter output apparatus configured to output a SPICE model parameter of a high-frequency or analog MOSFET for a simulation of a semiconductor circuit. The apparatus includes a data input part to input shape data of the MOSFET and measurement data on frequency characteristics of the MOSFET. The apparatus further includes a substrate resistance calculating part configured to calculate a substrate resistance of a one-terminal substrate resistance model regarding the MOSFET, based on the measurement data. The apparatus further includes a SPICE model parameter output part configured to calculate the SPICE model parameter, based on the substrate resistance of the one-terminal substrate resistance model and the shape data, to output the calculated SPICE model parameter.

Another embodiment described herein is, for example, a SPICE model parameter output method of outputting a SPICE model parameter of a high-frequency or analog MOSFET for a simulation of a semiconductor circuit. The method includes inputting shape data of the MOSFET and measurement data on frequency characteristics of the MOSFET into an information processing apparatus. The method further includes calculating a substrate resistance of a one-terminal substrate resistance model regarding the MOSFET by the information processing apparatus, based on the measurement data. The method further includes calculating the SPICE model parameter by the information processing apparatus, based on the substrate resistance of the one-terminal substrate resistance model and the shape data, to output the calculated SPICE model parameter.

Another embodiment described herein is, for example, a computer readable recording medium storing a program to cause a computer to execute a SPICE model parameter output method of outputting a SPICE model parameter of a high-frequency or analog MOSFET for a simulation of a semiconductor circuit. The method includes calculating a substrate resistance of a one-terminal substrate resistance model regarding the MOSFET, based on measurement data on frequency characteristics of the MOSFET inputted into the computer. The method further includes calculating the SPICE model parameter, based on the substrate resistance of the one-terminal substrate resistance model and shape data of the MOSFET inputted into the computer, to output the calculated SPICE mode parameter.

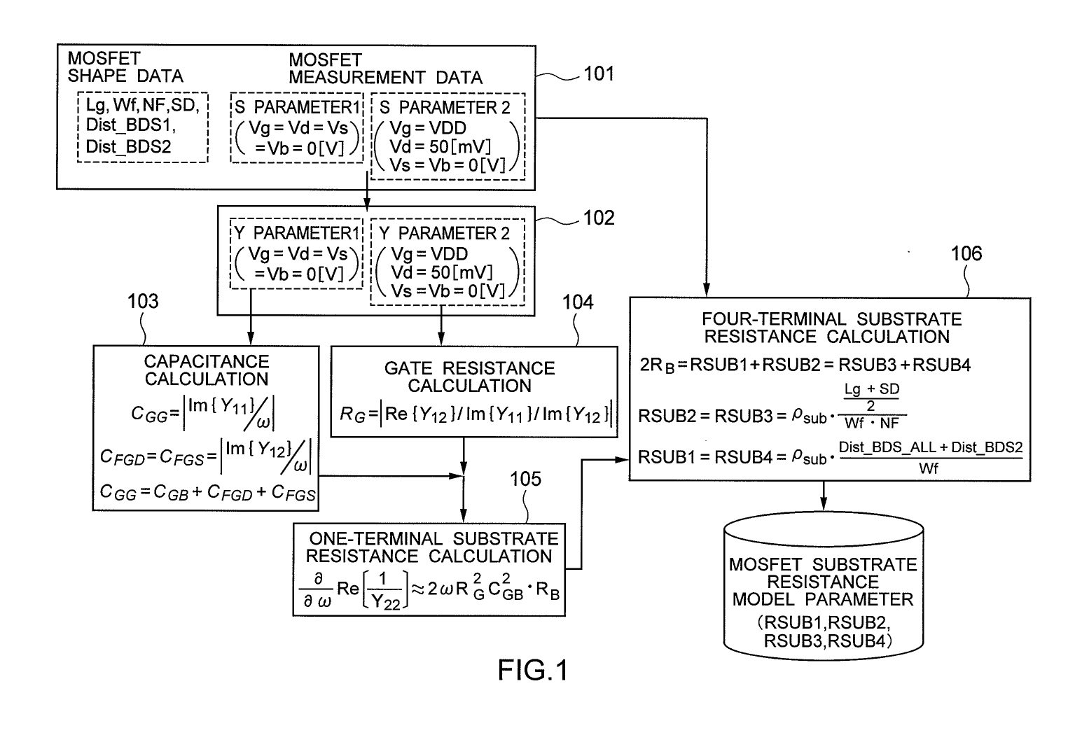

FIG. 1 is a schematic diagram showing a configuration of a SPICE model parameter output apparatus of an embodiment of the disclosure. The apparatus of FIG. 1 is configured to output a SPICE model parameter of a high-frequency MOSFET (RF-MOSFET) for a simulation of a semiconductor circuit.

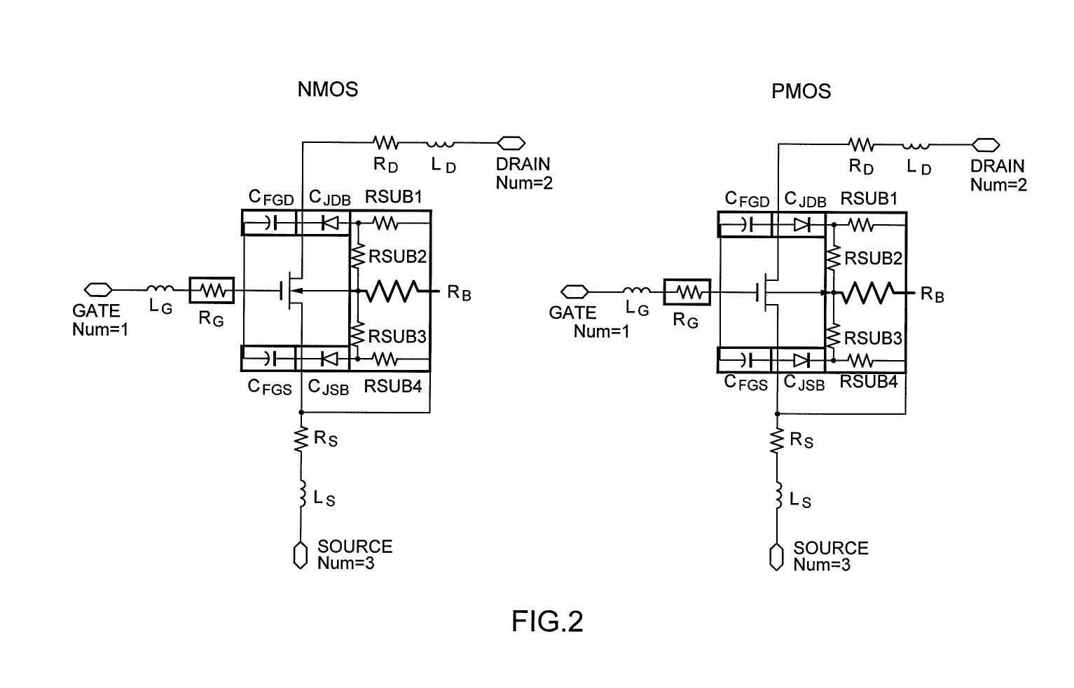

The apparatus of FIG. 1 includes, as blocks for such processing, a data input part 101, a Y parameter calculating part 102, a capacitance calculating part 103, a gate resistance calculating part 104, a one-terminal substrate resistance calculating part 105, and a four-terminal substrate resistance calculating part 106. The Y parameter calculating part 102, the capacitance calculating part 103, the gate resistance calculating part 104, and the one-terminal substrate resistance calculating part 105 are an example of a substrate resistance calculating part of the disclosure, and the four-terminal substrate resistance calculating part 106 is an example of a SPICE model parameter output part of the disclosure. The detailed operations of those blocks will be described with reference to FIGS. 2 to 11.

FIG. 2 is a circuit diagram showing general configurations of macro models of high-frequency MOSFETs. FIG. 2 shows circuit diagrams of an NMOS and a PMOS that are the high-frequency MOSFETs. In the present embodiment, the macro models shown in FIG. 2, or a SPICE model for an MOSFET including an equivalent circuit similar to one of the macro models in FIG. 2 are to be handled. FIG. 2 further shows a substrate resistance R_{B} of a one-terminal substrate resistance model, and substrate resistances RSUB1, RSUB2, RSUB3, and RSUB4 of a four-terminal substrate resistance model, with regard to each macro model.

With regard to each of such MOSFETs, the data input part 101 of FIG. 1 receives shape data of the MOSFET and measurement data on the frequency characteristics of the MOSFET.

In the present embodiment, as the shape data of the MOSFET, the data input part 101 receives a gate length Lg (unit: m), a unit finger length Wf (unit: m), a finger number NF, an adjacent gate distance SD (unit: m) between adjacent gates in the case of a multi-finger type MOSFET, a distance Dist_BDS1 (unit: m) from a source/drain edge to a back gate (well contact) except for dummy fingers, and a distance Dist_BDS2 (unit: m) from the source/drain edge to the back gate.

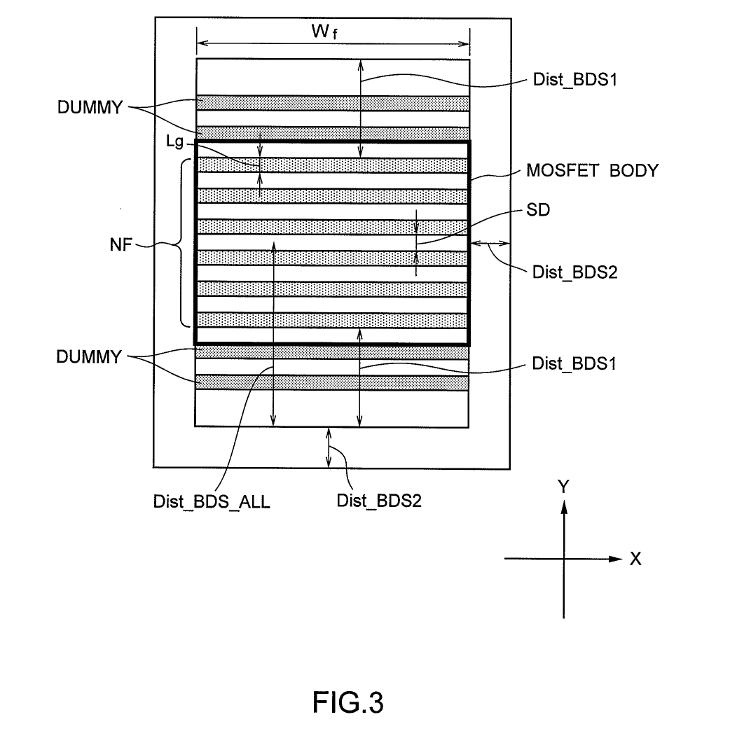

The details of such shape data are shown in FIG. 3. FIG. 3 is a plan view showing MOSFETs handled in the present embodiment, where the MOSFETs are arranged in the form of an array. In FIG. 3, a direction to which finger structures extend is shown by the arrow X, and a direction in which the finger structures are repeated is shown by the arrow Y. FIG. 3 further shows a distance Dist_BDS_ALL (unit: m) from the central portion of the MOSFET body to the back gate.

Further, in the present embodiment, as the measurement data on the frequency characteristics of the MOSFET, actual measurement values of S parameters (S parameter 1 and 2) in two bias states of the MOSFET are inputted (see, FIG. 1). The actual measurement values of the S parameters are measured using a measuring instrument such as a network analyzer.

The S parameter 1 corresponds to an S parameter when the MOSFET is turned off. The S parameter 1 is an S parameter when the voltages of all terminals of the MOSFET are 0 V, i.e., a gate voltage Vg, a drain voltage Vd, a source voltage Vs, and a substrate voltage Vb of the MOSFET are all 0 V.

Meanwhile, the S parameter 2 corresponds to an S parameter when the MOSFET is turned on. More specifically, the S parameter 2 is an S parameter when the MOSFET is operated in a linear operation region (triode region). In the present embodiment, the S parameter 2 is obtained by setting the gate voltage Vg to a power supply voltage VDD allowed by the MOSFET, setting the drain voltage Vd to approximately 50 mV, and setting the source voltage Vs and the substrate voltage Vb to 0 V. The value of the drain voltage Vd may be set to a value other than 50 mV.

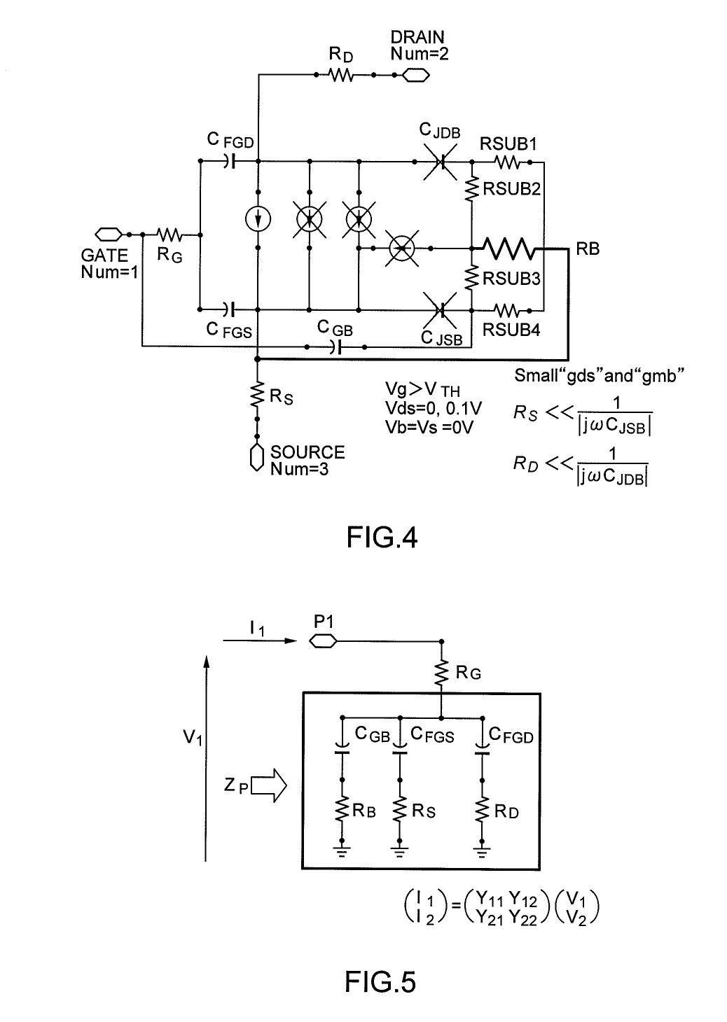

According to the above bias conditions, the state in which the influences of the conductances in the MOSFET are removed can be generated as shown in FIG. 4. FIG. 4 is a circuit diagram showing an internal equivalent circuit of the MOSFET when the S parameters 1 and 2 are measured. In FIG. 4, the influences of the conductances between the gate and the drain (gm), between the drain and the source (gds), and between the substrate and the drain/source (gmb) inherent in the MOSFET are removed, so that an obtained S parameter includes only the influence of a parasitic element.

According to the S parameter, the parasitic element can be observed directly, and the parasitic element added to the MOSFET to be used in high frequency can be calculated directly from the observed S parameter.

In the present embodiment, the shape data of the MOSFET is inputted into the apparatus of FIG. 1 by a user, for example. Further, the measurement data on the frequency characteristics of the MOSFET is measured, for example, by a measuring instrument such as a network analyzer and inputted into the apparatus of FIG. 1 from the measuring instrument. In the present embodiment, the measurement data measured by the measuring instrument may be inputted into the apparatus of FIG. 1 by a user.

Subsequently, the operations of the Y parameter calculating part 102, the capacitance calculating part 103, the gate resistance calculating part 104, and the one-terminal substrate resistance calculating part 105 of FIG. 1 will be described.

The Y parameter calculating part 102 transforms the S parameter into a Y parameter. Consequently, as the Y parameter when the voltages of all terminals of the MOSFET are 0 V, a Y parameter 1 is calculated from the S parameter 1. Further, as the Y parameter when the MOSFET is operated in the linear operation region, a Y parameter 2 is calculated from the S parameter 2 (see, FIG. 1). In this way, the S parameter is individually transformed into the Y parameter.

The Y parameters 1 and 2 are subjected to different processes. The Y parameter 1 is subjected to capacitance calculation processing performed by the capacitance calculating part 103. The Y parameter 2 is subjected to gate resistance calculation processing performed by the gate resistance calculating part 104.

Here, the details of the Y parameter (admittance matrix) will be described analytically.

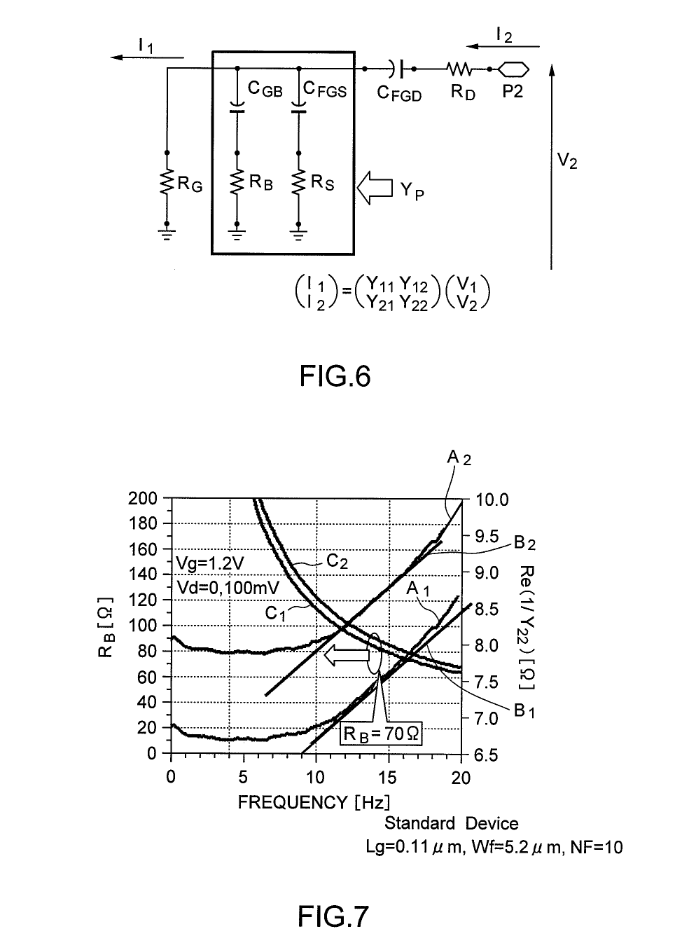

As described above, according to the above two bias conditions, the state in which the influences of the conductances in the MOSFET are removed can be generated as shown in FIG. 4. When an input and output admittance of the MOSFET is calculated under the bias conditions, the calculation can be started from the states shown in FIGS. 5 and 6. FIG. 5 is a circuit diagram showing an admittance that can be defined when the MOSFET is viewed from the gate side in the state shown in FIG. 4. FIG. 6 is a circuit diagram showing an admittance that can be defined when the MOSFET is viewed from the drain side in the state shown in FIG. 4.

From FIG. 5, a circuit equation represented by the expression (1) is obtained, and from FIG. 6, circuit equations represented by the expressions (2) and (3) are obtained, where, Y₁₁, Y₁₂, Y₂₁, and Y₂₂ represent components of the Y parameter, and Z_{P} and Y_{P} are given as the expressions (4) and (5), respectively.

$$\begin{matrix}{Y}_{11} = \frac{1}{{Z}_{in}} = {R}_{G} + Zp , & ( 1 ) \\ {Y}_{12} = \frac{{I}_{1}}{{V}_{2}} = {[ {R}_{G} + ( {R}_{D} + \frac{1}{jω {C}_{GB}} ) ( {Y}_{P} {R}_{G} + 1 ) ]}^{- 1} , & ( 2 ) \\ {Y}_{22} = \frac{{I}_{2}}{{V}_{2}} = {[ {R}_{D} + \frac{1}{j ω {C}_{FGD}} + \frac{1}{Yp + \frac{1}{{R}_{G}}} ]}^{- 1} , & ( 3 ) \\ Zp \approx {[ jω {C}_{GG} + {ω}^{2} ( {R}_{B} {C}_{GB}^{2} + {R}_{D} {C}_{GFD}^{2} + {R}_{S} {C}_{GFS}^{2} ) ]}^{- 1} , & ( 4 ) \\ Yp \approx [ jω ( {C}_{GB} + {C}_{FGS} ) + {ω}^{2} ( {R}_{B} {C}_{GB}^{2} + {R}_{S} {C}_{GFS}^{2} ) ] . & ( 5 )\end{matrix}$$

In the above expressions, R_{G}, R_{D}, and R_{S} respectively represent the gate resistance, the drain resistance, and the source resistance of the MOSFET. Further, R_{B} represents the substrate resistance of the MOSFET (of the one-terminal substrate resistance model). Further, C_{GG} and C_{GB} respectively represent a gate capacitance of the MOSFET and a gate-to-well capacitance between the gate and the well. Further, C_{FGD} and C_{FGS} represent the overlap capacitance of the MOSFET (see, FIGS. 5 and 6). Further, ω represents a frequency (angular frequency), and j represents an imaginary unit.

When the circuit equations (1) to (3) are solved, the Y parameter shown in the expressions (6) to (9) are obtained:

$$\begin{matrix}{Y}_{11} \approx {ω}^{2} ( {C}_{GG}^{2} {R}_{G} + {C}_{FGS}^{2} {R}_{S} + {C}_{FGD}^{2} {R}_{D} + {C}_{GB}^{2} {R}_{B} ) + jω {C}_{GG} , & ( 6 ) \\ {Y}_{12} \approx {ω}^{2} {C}_{GG} {C}_{FGD} {R}_{G} + jω {C}_{FGD} , & ( 7 ) \\ {Y}_{21} \approx {G}_{m} - {ω}^{2} {C}_{GG} {C}_{FGD} {R}_{G} - jω ( {C}_{FGD} + {G}_{m} {R}_{G} {C}_{GG} ) , & ( 8 ) \\ {Y}_{22} \approx {[ \begin{matrix}( {R}_{G} + {R}_{D} ) + {( ω {R}_{G} )}^{2} ( {R}_{B} {C}_{GB}^{2} + {R}_{S} {C}_{FGS}^{2} ) - \\ j \{ \frac{1}{ω {C}_{FGD}} + {R}_{G}^{2} ( {C}_{GB} + {C}_{FGS} ) \}\end{matrix} ]}^{- 1} . & ( 9 )\end{matrix}$$

Also, R_{B} is represented by the expression (10) using the substrate resistances RSUB1, RSUB2, RSUB3, and RSUB4 of the four-terminal substrate resistance model of the MOSFET. Also, C_{GG} is represented by the expression (11) using C_{GB}, C_{FGD} and C_{FGS}.

R_{B}=(RSUB1+RSUB3)/(RSUB2+RSUB4) (10),

C_{GG}=C_{GB}+C_{FGD}+C_{FGS} (11).

The capacitance calculating part 103 and the gate resistance calculating part 104 can extract parasitic parameters directly by using the relationship of the expressions (6) to (9). Specifically, the capacitance calculating part 103 calculates the gate capacitance C_{GG} from an imaginary part of Y₁₁ (see, expression (12)) and calculates the overlap capacitances C_{FGD} and C_{FGS} from an imaginary part of Y₁₂ (see, expression (13)). The capacitance calculating part 103 substitutes those capacitances into the expression (11) and calculates the gate-to-well capacitance C_{GB}. Meanwhile, the gate resistance calculating part 104 calculates the gate resistance R_{G} from the imaginary parts of Y₁₁ and Y₁₂ and a real part of Y₁₂ as in the expression (14).

$$\begin{matrix}{C}_{GG} = \vert \frac{Im \{ {Y}_{11} \}}{ω} \vert , & ( 12 ) \\ {C}_{FGD} = {C}_{FGS} = \vert \frac{Im \{ {Y}_{12} \}}{ω} \vert , & ( 13 ) \\ {R}_{G} = \vert Re \{ {Y}_{12} \} / Im \{ {Y}_{11} \} / Im \{ {Y}_{12} \} \vert . & ( 14 )\end{matrix}$$

As described above, the capacitance calculating part 103 and the gate resistance calculating part 104 can extract, from the Y parameter, the gate resistance R_{G}, the gate capacitance C_{GG}, the overlap capacitances C_{FGD} and C_{FGS}, and the gate-to-well capacitance C_{GS}.

Here, a real part of 1/Y₂₂ will be noted. The real part of 1/Y₂₂ is represented by the expression (15) using the expression (9):

$$Re ( \frac{1}{{Y}_{22}} ) \approx ( {R}_{G} + {R}_{D} ) + {( ω {R}_{G} )}^{2} ( {R}_{B} {C}_{GB}^{2} + {R}_{S} {C}_{FGS}^{2} ) . \qquad ( 15 )$$

The first term of the right side of the expression (15) does not depend on the frequency, and the second term depends on the frequency. As the frequency is lowered, the value of the real part of 1/Y₂₂ is closer to the value of the first term, and as the frequency is increased, the value of the second term becomes dominant. In a usual MOSFET, since R_{B}C_{GB}²>>R_{S}C_{FGS}² is established, the term of R_{S}C_{FGS}² in the second term can be ignored. Thus, the expression (15) can be deformed to the expression (16):

$$\frac{\partial }{\partial ω} Re ( \frac{1}{{Y}_{22}} ) \approx 2 ω {R}_{G}^{2} {C}_{GB}^{2} \cdot {R}_{B} . \qquad ( 16 )$$

By virtue of the use of the relationship of the expression (16), the one-terminal substrate resistance calculating part 105 can calculate the substrate resistance R_{B} of the one-terminal substrate resistance model, based on the Y parameter, the gate resistance R_{G}, and the gate-to-well capacitance C_{GB}. Specifically, the one-terminal substrate resistance calculating part 105 divides the tilt of a frequency-dependent term of the real part of 1/Y₂₂, corresponding to the right side of the expression (16) by 2ωR_{G}²C_{GB}², thereby calculating the substrate resistance R_{B}.

FIG. 7 is a graph showing the values of Re(1/Y₂₂) and the substrate resistance R_{B} actually obtained by the method of the present embodiment. The horizontal axis of FIG. 7 represents a frequency, and the vertical axis represents Re(1/Y₂₂) and the substrate resistance R_{B}. The graph of FIG. 7 is obtained from actual measurement data of 1.5V-VS NMOD by 110 nm RF-CMOS process.

In FIG. 7, curves A₁ and A₂ represent Re(1/Y₂₂), and lines B₁ and B₂ corresponding to the tangents of the curves A₁ and A₂ represent the tilt of Re(1/Y₂₂) at the frequency at the position of the contact point. The substrate resistance R_{B} can be calculated by dividing the tilt of Re(1/Y₂₂) by 2ωR_{G}²C_{GB}² in accordance with the relationship of the expression (16). The curves C₁ and C₂ represent the substrate resistance R_{B} thus calculated.

In this way, the Y parameter calculating part 102, the capacitance calculating part 103, the gate resistance calculating part 104, and the one-terminal substrate resistance calculating part 105 of FIG. 1 can calculate the substrate resistance R_{B} of the one-terminal substrate resistance model of the MOSFET, based on the measurement data on the frequency characteristics of the MOSFET.

Subsequently, the operation of the four-terminal substrate resistance calculating part 106 shown in FIG. 1 will be described. In the macro model of the high-frequency MOSFET, a four-terminal substrate resistance model or a five-terminal substrate resistance model is usually used. In the former, substrate resistances of the four-terminal substrate resistance model are calculated as the SPICE model parameter. In the latter, substrate resistances of the five-terminal substrate resistance model is calculated as the SPICE model parameter.

The four-terminal substrate resistance calculating part 106 calculates and outputs, as the SPICE model parameter, the substrate resistances RSUB1, RSUB2, RSUB3, and RSUB4 of the four-terminal substrate resistance model. Hereinafter, the details of the processing of calculating the substrate resistances of the four-terminal substrate resistance model will be described.

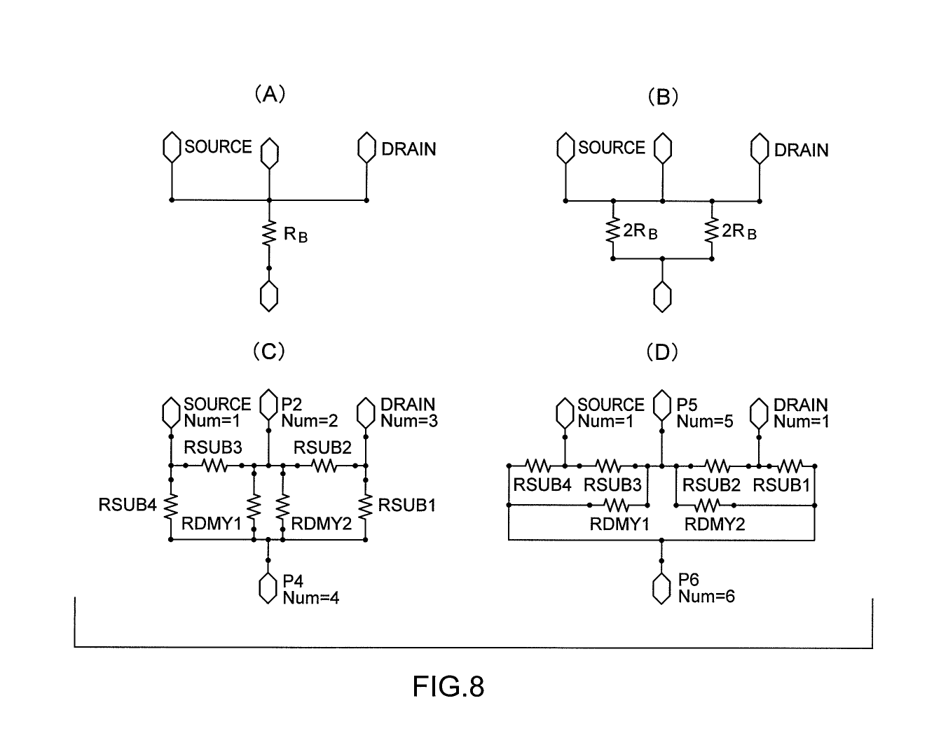

FIG. 8 is a circuit diagram for explaining a transformation from the one-terminal substrate resistance model to the four-terminal substrate resistance model.

FIG. 8(A) is a circuit diagram showing the substrate resistance R_{B} of the one-terminal substrate resistance model. The circuit diagram shown in FIG. 8(A) can be subjected to an equivalent circuit transformation to be transformed into the circuit diagram shown in FIG. 8(B). In FIG. 8(B), two resistances each having a resistance value 2R_{B} are connected in parallel.

Meanwhile, in the present embodiment, it can be regarded that the biases of the source and the drain of the MOSFET are equal (or substantially equal). Therefore, the circuit diagram shown in FIG. 8(A) can be subjected to the equivalent circuit transformation into the circuit diagram shown in FIG. 8(C) or 8(D). FIGS. 8(C) and 8(D) show four resistances having the resistance values RSUB1, RSUB2, RSUB3, and RSUB4, and two dummy resistances RDMY1 and RDMY2. Although the dummy resistances RDMY1 and RDMY2 are not required to be provided in the four-terminal substrate resistance model, they can be regarded as open resistances in the four-terminal substrate resistance model.

The transformation from the one-terminal substrate resistance model into the four-terminal substrate resistance model will be described with reference to FIG. 8(D). In FIG. 8(D), P5 represents a well directly under a gate, and P6 represents a well contact. Further, DRAIN and SOURCE represent contacts of a drain and a source, respectively.

The substrate resistance R_{B} obtained by the expression (16) is a resistance value calculated from the six resistances shown in FIG. 8(D). In the present embodiment, since the biases of the MOSFET are substantially equally applied to the source and the drain, it can be assumed that DRAIN and SOURCE of FIG. 8(D) have substantially the same potential. The resistances shown in FIG. 8(D) can be associated with the substrate resistance R_{B} by the expressions of the following expressions (17) and (18) (RDMY1 and RDMY2 can be ignored in this case):

2R_{B}=RSUB1+RSUB2 (17),

2R_{B}=RSUB3+RSUB4 (18).

The expression (17) represents that a left side resistance 2R_{B} shown in FIG. 8(B) is equal to a sum of RSUB1 and RSUB2 shown in FIG. 8(D). Meanwhile, the expression (18) represents that a right side resistance 2R_{B} shown in FIG. 8(B) is equal to a sum of RSUB3 and RSUB4 shown in FIG. 8(D).

If the inside of the well is formed of the same material, and the resistivity in the well is represented by the same value σ_{sub}, RSUB1 to RSUB4 are represented by the expressions (19) and (20):

$$\begin{matrix}R SUB 2 = R SUB 3 = {ρ}_{sub} \cdot \frac{\frac{Lg + SD}{2}}{Wf \cdot NF} , & ( 19 ) \\ R SUB 1 = R SUB 4 = {ρ}_{sub} \cdot \frac{Dist\_BDS \_ALL + Dist\_BDS 2}{Wf} . & ( 20 )\end{matrix}$$

When NF is an even number, Bist_BDS_ALL in the expression (20) is represented by the expression (21). When NF is an odd number, Bist_BDS_ALL in the expression (20) is represented by the expression (22). Note that int (NF/2) represents the integer portion of the value of NF/2, i.e., represents a value obtained by rounding the numbers after the decimal point of the value of NF/2.

$$\begin{matrix}{Dist\_BDS \_ALL = Dist\_BDS 1 + Lg \cdot \frac{NF}{2} + SD \cdot \frac{NF - 1}{2} ,}_{( NF = even )} & ( 21 ) \\ {Dist\_BDS \_ALL = Dist\_BDS 1 + Lg \cdot \frac{NF}{2} + SD \cdot int ( \frac{NF}{2} ) .}_{( NF = odd )} & ( 22 )\end{matrix}$$

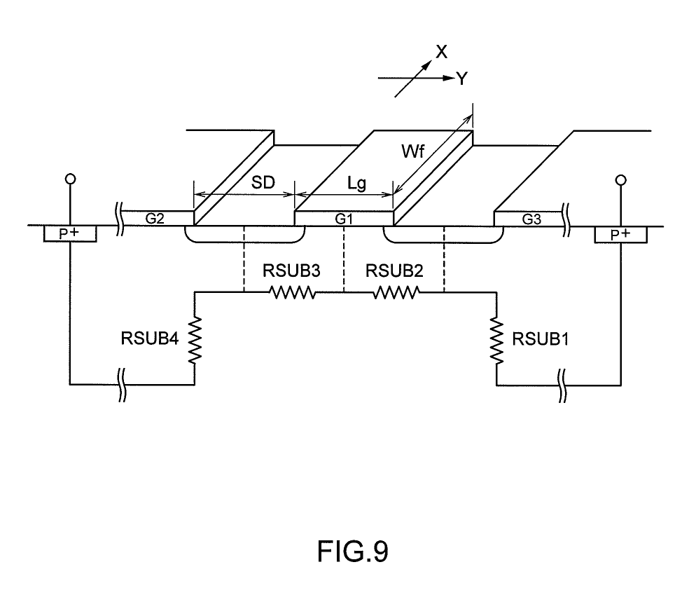

The expressions (19) and (20) can be derived by representing RSUB1 to RSUB4 by variables shown in FIG. 3, based on FIG. 9. FIG. 9 is a side cross-sectional view illustrated by associating the structure shown in FIG. 3 with the four-terminal substrate resistances RSUB1 to RSUB4.

The values of the variables shown in FIG. 3 are inputted as the shape data of the MOSFET into the data input part 101, as described above (see, FIG. 1). Therefore, the four-terminal substrate resistance calculating part 106 can substitute the one-terminal substrate resistance R_{B} calculated by the one-terminal substrate resistance calculating part 105 and the shape date inputted into the data input part 101 into the expressions (19) and (20), whereby the four-terminal substrate resistances RSUB1 to RSUB4 can be calculated. The calculated four-terminal substrate resistances RSUB1 to RSUB4 are outputted as the SPICE model parameter (substrate resistance model parameter) to the outside (or inside) of the apparatus of FIG. 1.

In this way, the four-terminal substrate resistance calculating part 106 can calculate the SPICE model parameter of the MOSFET, based on the substrate resistance R_{B} of the one-terminal substrate resistance model of the MOSFET and the shape data of the MOSFET, to output the calculated parameter. In the present embodiment, the four-terminal substrate resistance calculating part 106 calculates and outputs, as the SPICE model parameter, the substrate resistances RSUB1 to RSUB4 of the four-terminal substrate resistance model of the MOSFET.

Here, the four-terminal substrate resistances RSUB1 to RSUB4 will be calculated from the one-terminal substrate resistance R_{B}=70Ω obtained in FIG. 7. As the shape data, Lg=0.11 μm, Wf=5.2 μm, NF=10, SD=0.5 μm, and Dist_BDS1=Dist_BDS2=1 μm are to be used. In this case, the resistivity ρ_{sub} and the four-terminal substrate resistances RSUB1 to RSUB4 are calculated as the following values:

ρ_{sub}=323Ω,

RSUB2=RSUB3=15.9Ω,

RSUB1=RSUB4=68.3Ω.

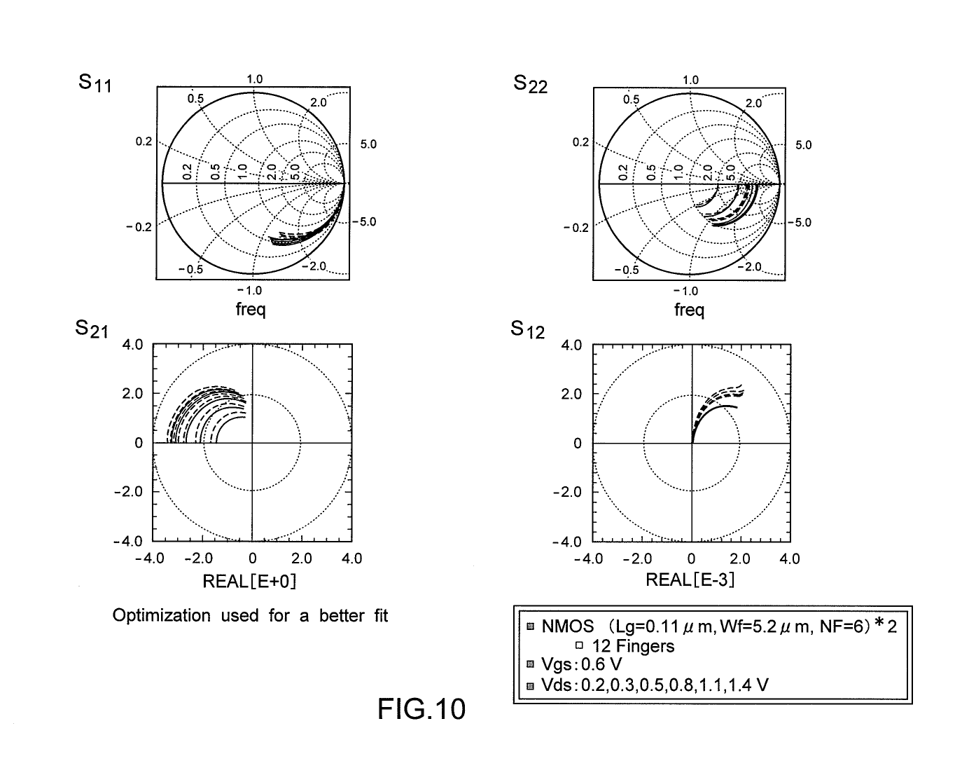

FIG. 10 is a graph in which the model of the present embodiment and a measured result are compared using the values of RSUB1 to RSUB4 obtained by the method of the present embodiment. In FIG. 10, the solid lines show the model of the present embodiment, and the dashed lines show the measured result.

As described above, in the present embodiment, the substrate resistance of the one-terminal substrate resistance model is calculated based on the measurement data on the frequency characteristics of the MOSFET, and the SPICE model parameter of the MOSFET is calculated and outputted based on the shape data of the MOSFET and the substrate resistance of the one-terminal substrate resistance model. According to the present embodiment, the substrate resistances of the four-terminal substrate resistance model can be calculated and outputted as the SPICE model parameter, for example.

In this way, according to the present embodiment, the substrate resistance model parameter of the MOSFET (for example, the four-terminal substrate resistances RSUB1 to RSUB4) can be calculated from the actual measurement value.

Further, in the present embodiment, the substrate resistance model parameter such as the four-terminal substrate resistances is calculated not by the method of varying the value of the parameter but by using the one-terminal substrate resistance calculated from the actual measurement value, so that the substrate resistances of the high-frequency MOSFET are accurately modeled, and a correct substrate resistance model parameter can be obtained. According to the present embodiment, a highly accurate MOSFET scalable model required for a PDK (Process Design Kit) development can be easily realized. Further, in the present embodiment, without depending on an optimization procedure of the substrate resistance model parameter, the substrate resistance model parameter is calculated from the actual measurement value, and therefore the robustness of the model parameter is maintained.

Furthermore, in the present embodiment, the S parameter is used as the actual measurement value and transformed into the Y parameter, and the one-terminal substrate resistance is calculated from the Y parameter obtained by the transformation. In the present embodiment, by virtue of the use of the relationship of the expression (16), the one-terminal substrate resistance can be easily calculated from the Y parameter.

As the actual measurement value, it is assumed that not the S parameter but the Y parameter may be used; however in this case, V₁=0 and V₂=0 (see, FIGS. 5 and 6) are required to be realized by a short circuit between terminals. However, there is a problem that it is difficult to realize V₁=0 and V₂=0 in a high-frequency region. Therefore, in the present embodiment, the problem is avoided by using the S parameter as the actual measurement value.

In the present embodiment, the S parameters in the two bias states (i.e., S parameters 1 and 2) are used. The S parameter 1 corresponds to an S parameter when the MOSFET is turned off. The S parameter 1 is an S parameter when the voltages of all terminals of the MOSFET are 0 V. Meanwhile, the S parameter 2 corresponds to an S parameter when the MOSFET is turned on. More specifically, the S parameter 2 is an S parameter when the MOSFET is operated in the linear operation region.

In the present embodiment, by using the above bias conditions, the state in which the influences of the conductances in the MOSFET are removed can be generated. The S parameters include purely the influences of the parasitic elements. Consequently, in the present embodiment, the values of the parasitic elements of the MOSFET can be calculated with high accuracy.

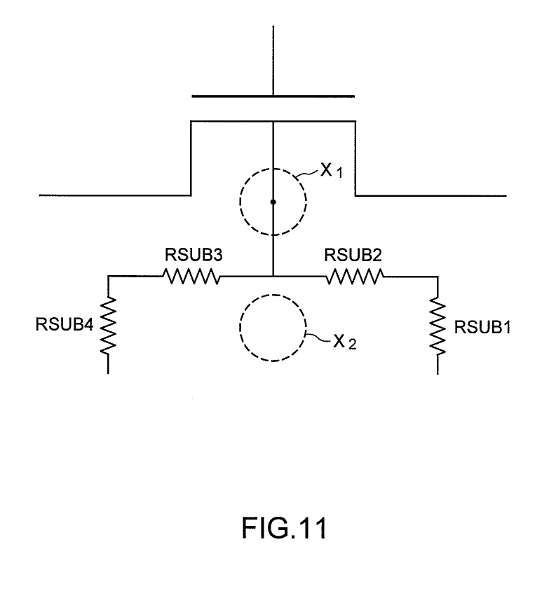

The relation between the parasitic elements and the thermal noise will be described with reference to FIG. 11. FIG. 11 is a circuit diagram showing the parasitic elements of the MOSFET handled in the present embodiment. FIG. 11 shows the MOSFET and the four-terminal substrate resistances RSUB1 to RSUB4.

It is considered that there are two main causes for the thermal noise of the MOSFET, one of which is the thermal noise of a channel, and the other of which is the thermal noise of a well. In FIG. 11, an approximate position where the thermal noise of the channel is generated is represented by a circle X₁, and an approximate position where the thermal noise of the well is generated is represented by a circle X₂.

In general, when the thermal noise in the MOSFET is considered, the thermal noise of the channel is calculated. However, according to a known document, it is regarded that the thermal noise of the well accounts for approximately ⅓ of the total thermal noise. Therefore, to estimate the thermal noise in the MOSFET accurately, the thermal noise of the channel should also be considered.

As shown in FIG. 11, the thermal noise of the well is influenced by the substrate resistances which are the parasitic elements. According to the present embodiment, not only the one-terminal substrate resistance but also the four-terminal substrate resistances can be accurately calculated, so that the thermal noise of the well can be accurately modeled. Consequently, the accuracy of noise simulation can be enhanced.

Hereinafter, a variation of the present embodiment will be described.

In the present embodiment, the four-terminal substrate resistances as the SPICE model parameter are calculated and outputted using the one-terminal substrate resistance. However, in the present embodiment, an N-terminal substrate resistances (N is an integer of 2 or more) other than the four-terminal substrate resistances may be calculated and outputted using the one-terminal substrate resistance. An example of the N-terminal substrate resistances is five-terminal substrate resistances.

The processing performed by the apparatus of FIG. 1 may be realized by a circuit which executes the processing, or may be realized by a computer program for causing a computer to execute the processing, for example. The computer program is recorded in a computer readable recording medium such as a CD-ROM, DVD, a semiconductor memory, and a magnetic memory and then used. A computer including the above circuit and a computer installed with the above computer program are examples of an information processing apparatus of the disclosure.

The SPICE model parameter outputted according to the present embodiment is to be used in the circuit simulation by SPICE. An apparatus executing the circuit simulation may be an apparatus including the apparatus of FIG. 1, or may be a separate apparatus from the apparatus of FIG. 1. The apparatus executing the circuit simulation can be realized by installing a SPICE program in the apparatus. According to the present embodiment, for example, the accuracy of the noise simulation by SPICE can be enhanced.

The present embodiment is applicable not only to the high-frequency MOSFET but also to various analog MOSFETs. In this case, the present embodiment is applicable not only to the high-frequency circuit design but also a low-frequency circuit design.

As described above, in the present embodiment, the substrate resistance of the one-terminal substrate resistance model is calculated based on the measurement data on the frequency characteristics of the MOSFET. Further, the SPICE model parameter of the MOSFET is calculated based on the shape data of the MOSFET and the substrate resistance of the one-terminal substrate resistance model, and the calculated SPICE model parameter is outputted. Consequently, in the present embodiment, the substrate resistances of the high-frequency MOSFET or the analog MOSFET can be accurately modeled, and the SPICE model parameter reflecting the correct substrate resistances can be outputted.

In the present embodiment, as the SPICE model parameter, the substrate resistance model parameters such as the four-terminal substrate resistances can be calculated and outputted. Accordingly, in the present embodiment, the correct substrate resistance model parameters can be outputted as the SPICE model parameter.

As described above, the embodiments described herein can provide a SPICE model parameter output apparatus and method and a recording medium, which can realize the accurate modeling of the substrate resistances of the high-frequency MOSFET and the analog MOSFET.

While certain embodiments have been described, these embodiments have been presented by way of example only, and are not intended to limit the scope of the inventions. Indeed, the novel apparatuses, methods and media described herein may be embodied in a variety of other forms; furthermore, various omissions, substitutions and changes in the form of the apparatuses, methods and media described herein may be made without departing from the spirit of the inventions. The accompanying claims and their equivalents are intended to cover such forms or modifications as would fall within the scope and spirit of the inventions.

1. A SPICE model parameter output apparatus configured to output a SPICE model parameter of a high-frequency or analog MOSFET for a simulation of a semiconductor circuit, the apparatus comprising:
a data input part to input shape data of the MOSFET and measurement data on frequency characteristics of the MOSFET;
a substrate resistance calculating part configured to calculate a substrate resistance of a one-terminal substrate resistance model regarding the MOSFET, based on the measurement data; and
a SPICE model parameter output part configured to calculate the SPICE model parameter, based on the substrate resistance of the one-terminal substrate resistance model and the shape data, to output the calculated SPICE model parameter.

2. The apparatus of claim 1, wherein
the measurement data is an S parameter measured using a network analyzer.

3. The apparatus of claim 2, wherein
the substrate resistance calculating part calculates the substrate resistance, based on the S parameter when the MOSFET is turned off, and the S parameter when the MOSFET is turned on.

4. The apparatus of claim 3, wherein
the substrate resistance calculating part calculates the substrate resistance, based on the S parameter when a gate voltage, a drain voltage, a source voltage, and a substrate voltage of the MOSFET are all 0 V, and the S parameter when the MOSFET is operated in a linear operation region.

5. The apparatus of claim 2, wherein the substrate resistance calculating part is configured to:
transform the S parameter into a Y parameter,
extract a gate resistance, an overlap capacitance, a gate capacitance, and a gate-to-well capacitance of the MOSFET, from the Y parameter, and
calculate the substrate resistance, based on the Y parameter, the gate resistance, and the gate-to-well capacitance.

6. The apparatus of claim 5, wherein
the substrate resistance calculating part calculates the gate capacitance, based on an imaginary part of a Y₁₁ component of the Y parameter.

7. The apparatus of claim 5, wherein
the substrate resistance calculating part calculates the overlap capacitance, based on an imaginary part of a Y₁₂ component of the Y parameter.

8. The apparatus of claim 5, wherein
the substrate resistance calculating part calculates the gate resistance, based on an imaginary part of a Y₁₁ component, an imaginary part of a Y₁₂ component, and a real part of the Y₁₂ component of the Y parameter.

9. The apparatus of claim 5, wherein
the substrate resistance calculating part calculates the substrate resistance of the one-terminal substrate resistance model, based on a real part of a 1/Y₂₂ component of the Y parameter, the gate resistance, and the gate-to-well capacitance.

10. The apparatus of claim 1, wherein
the SPICE model parameter output part calculates substrate resistances of an N-terminal substrate resistance model regarding the MOSFET as the SPICE model parameter, to output the calculated substrate resistances of the N-terminal substrate resistance model, where N is an integer of 2 or more.

11. The apparatus of claim 10, wherein
the N-terminal substrate resistance model is a four-terminal or five-terminal substrate resistance model.

12. The apparatus of claim 1, wherein
the shape data comprises at least one of a gate length, a unit finger length, a finger number, and an adjacent gate distance of the MOSFET.

13. A SPICE model parameter output method of outputting a SPICE model parameter of a high-frequency or analog MOSFET for a simulation of a semiconductor circuit, the method comprising:
inputting shape data of the MOSFET and measurement data on frequency characteristics of the MOSFET into an information processing apparatus;
calculating a substrate resistance of a one-terminal substrate resistance model regarding the MOSFET by the information processing apparatus, based on the measurement data; and
calculating the SPICE model parameter by the information processing apparatus, based on the substrate resistance of the one-terminal substrate resistance model and the shape data, to output the calculated SPICE model parameter.

14. The method of claim 13, wherein
the measurement data is an S parameter measured using a network analyzer.

15. The method of claim 14, wherein
the substrate resistance is calculated based on the S parameter when the MOSFET is turned off, and the S parameter when the MOSFET is turned on.

16. The method of claim 15, wherein
the substrate resistance is calculated based on the S parameter when a gate voltage, a drain voltage, a source voltage, and a substrate voltage of the MOSFET are all 0 V, and the S parameter when the MOSFET is operated in a linear operation region.

17. The method of claim 14, wherein the calculation of the substrate resistance comprising:
transforming the S parameter into a Y parameter,
extracting a gate resistance, an overlap capacitance, a gate capacitance, and a gate-to-well capacitance of the MOSFET, from the Y parameter, and
calculating the substrate resistance, based on the Y parameter, the gate resistance, and the gate-to-well capacitance.

18. The method of claim 13, wherein
the SPICE model parameter is substrate resistances of an N-terminal substrate resistance model regarding the MOSFET, where N is an integer of 2 or more.

19. The method of claim 18, wherein
the N-terminal substrate resistance model is a four-terminal or five-terminal substrate resistance model.

20. A computer readable recording medium storing a program to cause a computer to execute a SPICE model parameter output method of outputting a SPICE model parameter of a high-frequency or analog MOSFET for a simulation of a semiconductor circuit, the method comprising:
calculating a substrate resistance of a one-terminal substrate resistance model regarding the MOSFET, based on measurement data on frequency characteristics of the MOSFET inputted into the computer; and
calculating the SPICE model parameter, based on the substrate resistance of the one-terminal substrate resistance model and shape data of the MOSFET inputted into the computer, to output the calculated SPICE mode parameter.
